(19) United States
(12) Patent Application Publication
(10) Pub. No.: US 2017/0098027 A1
(43) Pub. Date: Apr. 6, 2017

(54) AREA AWARE SCHEMATIC DESIGN BY ANALYSING AREA OF EACH COMPONENT USING SCRIPTING LANGUAGES

(71) Applicant: Signalchip Innovations Private Limited, Bangalore (IN)

(72) Inventors: Himamshu Gopalakrishna Khasnis, Bengaluru (IN); Kishan Srivathsan, Bengaluru (IN); Bharat Bhat, Gadag (IN)

(21) Appl. No.: 15/285,862

(22) Filed: Oct. 5, 2016

(30) Foreign Application Priority Data
Oct. 5, 2015 (IN) 5331/CHE/2015

(51) Int. Cl. G06F 17/50

(52) U.S. Cl. CPC G06F 17/5081; G06F 17/5072

(57) ABSTRACT

An area aware schematic design system that analyses an area of one or more components in a schematic circuit using scripting tools to generate an optimised component placement layout design for designing the schematic circuit is provided. The area aware schematic design system includes one or more modules as follows. A schematic circuit design module designs a schematic circuit. A schematic netlist analysing module performs an analysis on the schematic circuit. A component area parameter module calculates an area of the one or more components. A component information updation module obtains a second set of component information. A circuit design optimisation module design and optimise the schematic circuit design based on the second set component information. A component placement layout module generates an optimized component placement layout design. A layout closure module delivers the optimised component placement layout design.

### CROSS-REFERENCE TO RELATED APPLICATIONS

This application claims priority to Indian patent application no. 5331/CHE/2015 filed on Oct. 5, 2015, the complete disclosure of which, in its entirely, is herein incorporated by reference.

### BACKGROUND

Technical Field

The embodiments herein generally relate to the field of electronic design, automation tool, and more particularly the embodiments relate to a system and a method for area aware schematic design based on analysis of area of each component.

Description of the Related Art

Nowadays, design and manufacturing of electronic circuits, includes a schematic netlist and a layout closure. In this approach, a schematic designer first creates the schematic circuit using a design tool. Once the schematic circuit is designed and verified, then a layout is designed. Area taken up by each component is apparent to the schematic designer only after placement of various components in the layout. Once placement is done, if the schematic designer observes that certain components occupy more area than his estimate, the schematic designer goes back and changes the schematic circuit. Then the verification of the design is done followed by the placement of components in the layout for the new design. This process is carried out iteratively until all the components in the design occupy an optimum area.

FIG. 1 illustrates a block diagram of a conventional system 100 for analyzing an area of a schematic circuit according to a prior art. The conventional system 100 analyses area of one or more components of a schematic circuit. The conventional system 100 includes a schematic circuit design module 102, a placement layout module 104, a visual realization module 106, and a layout closure module 108. The schematic circuit design module 102 designs a schematic circuit to be compatible with circuit specifications. The placement layout module 104 places all components (that is associated with the schematic circuit) in the layout based on the schematic circuit obtained in the schematic circuit design module 102. In one embodiment the placement layout module 104 performs a layout-design. The layout-design expresses the three-dimensional disposition of the elements of the schematic circuit and some or all of the interconnections of the schematic circuit. After completion of the layout design, the visual realization module 106 performs computation of the component area of the layout. These three modules are used iteratively until all components present in the schematic circuit occupy optimum area. The schematic design module 102 making changes in the schematic circuit when the visual realization module 106 fails to produce the schematic circuit with optimum area utilization. The placement layout module 104 generates the layout based on the schematic designed in the schematic design module 102. Finally, the layout closure module 108 generates the desired layout. In the conventional system 100, a small component in the schematic circuit corresponds to more than five layers in the layout. If small changes need to be done post-layout, the entire component must be redone and placement of other components around it will need to be changed as well. Hence, iterations done after post layout takes more time for computation. Calculating area of the one or more components by the schematic designer consumes time when number of components in the design is more than five.

Accordingly, there remains a need for a system to analyse an area of a component in a schematic circuit in efficient way and to modify a design of the schematic circuit for better utilization.

### SUMMARY

In view of a foregoing, an embodiment herein provides an area aware schematic design system is provided. The area aware schematic design system analyses an area of one or more components in a schematic circuit using scripting tools to generate an optimised component placement layout design for designing the schematic circuit. The area aware schematic design system includes (a) a memory unit, and (b) a processor. The memory unit stores a database, and a set of modules. The processor executes the set of modules. The set of modules includes a schematic circuit design module, a component area parameter module, a component information updation module, a circuit design optimisation module, a component placement layout module, and a layout closure module. The schematic circuit design module designs the schematic circuit including one or more of components to be compatible with circuit specifications of the one or more of components based on a first set of component information that includes a first width of the one or more of components, first length of the one or more of components, at least one finger of the one or more of components, and at least one multiplier of the one or more of components. The component area parameter module calculates an area of (a) at least one component of the one or more of components, (b) at least one component type of the one or more of components, and (c) at least one group of components of the one or more of components.

The component information updation module obtains a second set of component information including a second length of the one or more of components, a second width of the one or more of components, at least one finger of the one or more of components, and at least one multiplier of the one or more of components. The second set of component information is optimised for area based on area parameters including the area of the (a) at least one component of the one or more of components, (b) at least one component type of the one or more of components, and (c) at least one group of components of the one or more of components. The circuit design optimisation module designs and optimises the schematic circuit design based on the second set component information that is optimised for area based on the area parameters. The component placement layout module generates an optimised component placement layout design based on the second set of component information that is optimised for area based on the area parameters. The layout closure module delivers the optimised component placement layout design as a final output for generating an optimized circuit.

In one embodiment, the area aware schematic design system further includes a schematic netlist analysing module. The schematic netlist analysing module performs a schematic netlist analysis on the schematic circuit to compute an area for each of the one or more of components in the schematic circuit. The schematic netlist analysing module includes a schematic netlist exporting module, a schematic netlist parse module, a component information based report generating module, a graphical chart generating module. The schematic netlist exporting module exports a schematic netlist from the schematic circuit. The schematic netlist parse module parses the schematic netlist to obtain the component information associated with the one or more of components. The component information based report generating module (a) processes the component information associated with the one or more of components to (i) calculates an area for each of the one or more components, (ii) calculates an area for each of the one or more components type and (iii) calculates an area for each of the one or more components group, and (b) generates an area report based on the area of the one or more of components. The graphical chart generating module generates a graphical chart based on the area report using the scripting tools.

In one embodiment, the schematic circuit design module modifies the schematic circuit based on the optimised schematic circuit design. In another embodiment, the second set of component information is obtained based on an iterative process of optimising for area based on the area parameters. In yet another embodiment, the component area parameter module displays the first area of (a) at least one component of the one or more of components, (b) at least one component type of the one or more of components, and (c) at least one group of components of the one or more of components. In yet another embodiment, the component information updation module displays the second area of (a) at least one component of the one or more of components, (b) at least one component type of the one or more of components, and (c) at least one group of components of the one or more of components.

In yet another embodiment, the area aware schematic design system further includes a component area parameter verification module. The component area parameter verification module performs a verification whether the first set of area parameters meet a pre-defined condition in the first set of component information. The component information updation module determines the second set of component information based on a result of the verification. In one embodiment, the second set of component information is generated by reducing at least one of the area by component, the area by component type, the area by component group for at least one of lower priority comp type or group.

In one aspect, an area aware schematic design system is provided. The area aware schematic design system analyses an area of a one or more of components in a schematic circuit using scripting tools to generate an optimised component placement layout design for designing the schematic circuit. The area aware schematic design system includes (a) a memory unit, and (b) a processor. The memory unit stores (i) a database, and set of modules. The processor executes the set of modules. The set of modules includes a schematic circuit design module, a schematic netlist analysing module, a component area parameter module, a component information updation module, a circuit design optimisation module, a component placement layout module, a layout closure module, and a component area parameter verification module. The schematic circuit design module designs the schematic circuit including the one or more of components to be compatible with circuit specifications of the one or more of components based on a first set of component information that includes a first width of the one or more of components, first length of the one or more of components, at least one finger of the one or more of components, and at least one multiplier of the one or more of components. The schematic circuit design module modifies the schematic circuit based on the optimised schematic circuit design.

The schematic netlist analysing module performs a schematic netlist analysis on the schematic circuit to compute an area for each of the one or more of components in the schematic circuit. The schematic netlist analysing module includes a schematic netlist exporting module, a schematic netlist parse module, a component information based report generating module, and a graphical chart generating module. The schematic netlist exporting module exports a schematic netlist from the schematic circuit. The schematic netlist parse module parses the schematic netlist to obtain the component information associated with the one or more of components. The component information based report generating module (a) to (i) calculate an area for each of the one or more components, (ii) calculates an area for each of the one or more components type and (iii) calculates an area for each of the one or more components group, and (b) generates an area report based on the area of the one or more of components. The graphical chart generating module generates a graphical chart based on the area report using the scripting tools. The component area parameter module calculates an area of (a) at least one component of the one or more of components, (b) at least one component type of the one or more of components, and (c) at least one group of components of the one or more of components. The component area parameter module displays the first area of (a) at least one component of the one or more of components, (b) at least one component type of the one or more of components, and (c) at least one group of components of the one or more of components.

The component information updation module obtains a second set of component information including a second length of the one or more of components, a second width of the one or more of components, at least one finger of the one or more of components, and at least one multiplier of the one or more of components. The second set of component information is optimised for area based on area parameters including the area of the (a) at least one component of the one or more of components, (b) at least one component type of the one or more of components, and (c) at least one group of components of the one or more of components. The second set of component information is obtained based on an iterative process of optimising for area based on the area parameters. The component information updation module displays the second area of (a) at least one component of the one or more of components, (b) at least one component type of the one or more of components, and (c) at least one group of components of the one or more of components.

The second set of component information is generated by reducing at least one of the area by component, the area by component type, the area by component group for at least one of lower priority comp type or group. The circuit design optimisation module modifies a design of the one or more of components to obtain an optimised schematic circuit design when the area of the one or more components are higher than a pre-determined area of the one or more of components. The component placement layout module generates an optimised component placement layout design based on the second set of component information that is optimised for area based on the area parameters. The layout closure module delivers the optimised component placement layout design as a final output for generating an optimized circuit. The component area parameter verification module performs a verification whether the first set of area parameters meet a pre-defined condition in the first set of component information. The component information updation module determines the second set of component information based on a result of the verification.

In one embodiment, the scripting tools includes a custom dropdown menu. The custom dropdown menu includes an area analysis by name sub-menu, an area analysis by type sub-menu, an area analysis by group sub-menu, and a layout area estimate sub-menu. The area analysis by name sub-menu is configured to generate the graphical chart based on a name of the one or more of components. The graphical chart displays an area occupied by the one or more of components along with the name of the one or more of components. The area analysis by type sub-menu is configured to generate the graphical chart based on a type of the one or more of components. The graphical chart displays an area occupied by the type of the one or more of components. The area analysis by group sub-menu is configured to generate the graphical chart based on a group of the one or more of components. The graphical chart displays an area occupied by the group of the one or more of components. The layout area estimate sub-menu is configured to generate the graphical chart based on an estimate of area utilization of the one or more of components post designing the schematic circuit.

In another embodiment, the second set of component information is determined based on a percentage of an area occupied by a component, which is calculated by dividing the area of the component with a total area of the schematic circuit. In yet another embodiment, the area of the one or more of components is calculated by multiplying (a) width of the one or more of components, (b) length of the one or more of components, (c) finger of the one or more of components, and (d) multiplier of the one or more of components.

In another aspect, a method for analysing an area of one or more of components in a schematic circuit using scripting tools to generate an optimised component placement layout design for designing the schematic circuit. The method including the step of: (a) designing, using a schematic circuit design module, the schematic circuit including the one or more of components to be compatible with circuit specifications of the one or more of components. The one or more of components includes component information that includes width of the one or more of components, length of the one or more of components, finger of the one or more of components, and multiplier of the one or more of components; (b) analysing, using a schematic netlist analysing module (204), the schematic circuit to compute the area for each of the one or more of components in the schematic circuit; The analyzing includes the step of: (i) exporting a schematic netlist from the schematic circuit; (ii) parsing the schematic netlist to obtain the component information associated with the one or more of components; (iii) processing the component information associated with the one or more of components to calculate an area of the one or more of components; (iv) modifying, using a circuit design optimisation module, a design of the one or more of components to obtain an optimised schematic circuit design when the area of the one or more of components are higher than a pre-determined area of the one or more components; (c) generating, using a component placement layout module, an optimised component placement layout design based on the optimised schematic circuit design; and (d) delivering, using a layout closure module, the optimised component placement layout design for designing the schematic circuit.

In one embodiment, the method further includes the step of: (e) generating an area report based on the area of the one or more of components; and (f) generating a graphical chart based on the area report using the scripting tools.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed descriptions with reference to the drawings, where:

FIG. 1 illustrates a block diagram of a conventional system for analyzing an area of a schematic circuit according to a prior art;

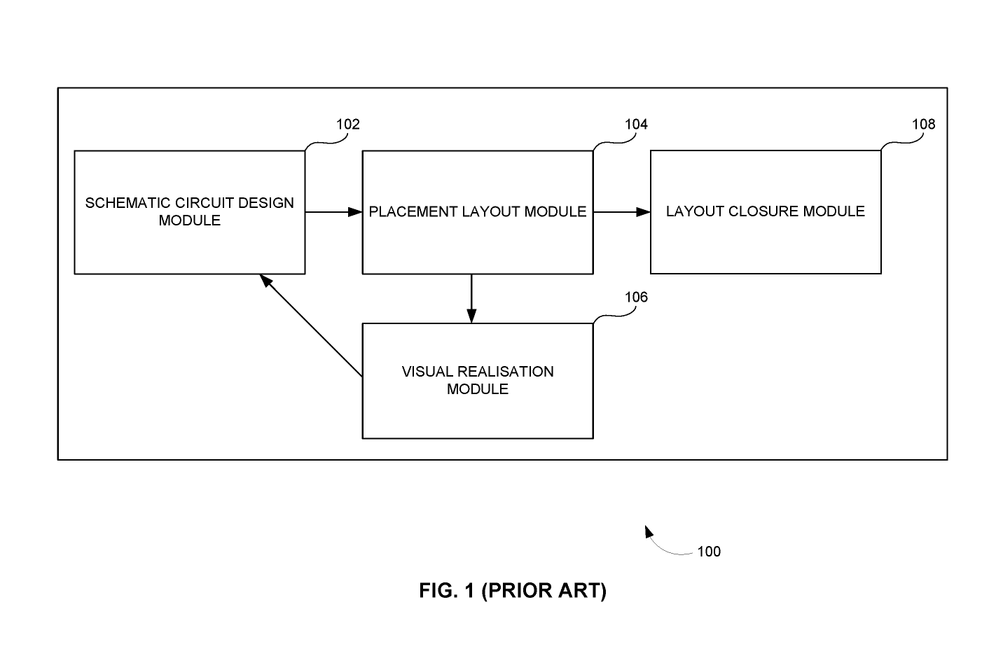

FIG. 2 illustrates an exploded view of an area aware schematic design system for analysing an area of one or more components in a schematic circuit according to embodiment;

FIG. 3 illustrates an exploded view of a schematic netlist analysing module of FIG. 2 according to an embodiment herein;

FIG. 4 illustrates an exploded view of a custom dropdown menu of a scripting tool according to an embodiment herein;

FIG. 5 illustrates a graphical chart of a schematic circuit that is generated using an area analysis by name sub-menu of FIG. 4 according to an embodiment herein; and

FIG. 6 is a flow diagram that illustrates a method for analyzing an area of one or more components in a schematic circuit using the area aware schematic design system of FIG. 2 according to an embodiment herein.

### DETAILED DESCRIPTION OF PREFERRED EMBODIMENTS

The embodiments herein and the various features and advantageous details are explained more with reference to the non-limiting embodiments that are illustrated in the accompanying drawings and details in the following description. Descriptions of well-known components and processing techniques are omitted so as they unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed for limiting the scope of the embodiments herein.

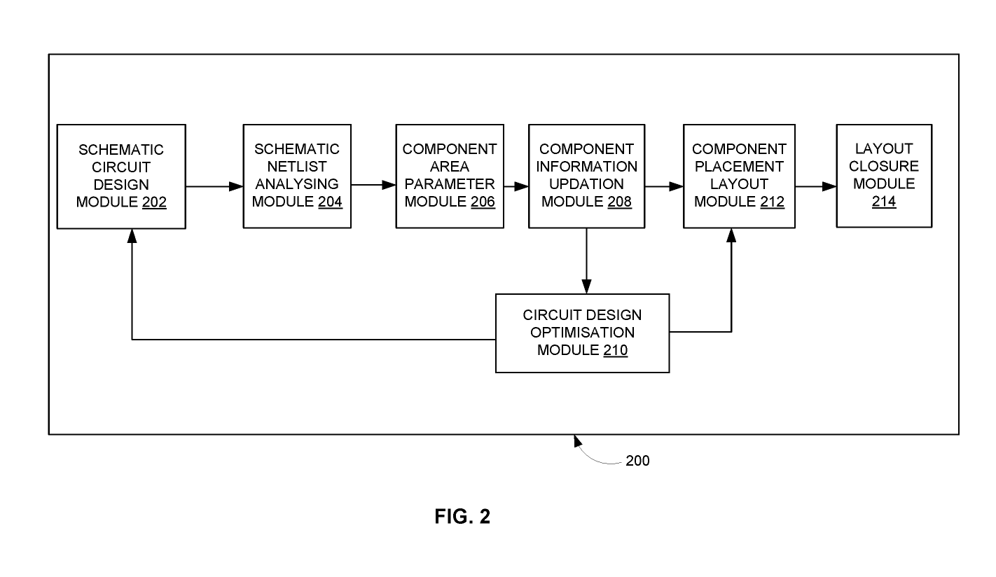

Various embodiments disclosed herein provide an area aware schematic design system that analyses an area of one or more components in a schematic circuit using scripting tools to generate an optimised component placement layout design for designing the schematic circuit. Referring to the drawings particularly to FIGS. 2 to 6, where similar reference characters denote corresponding features. Consistently throughout the figures, they are shown as preferred embodiments.

FIG. 2 illustrates an exploded view of an area aware schematic design system 200 for analysing an area of one or more components in a schematic circuit according to embodiment. The aware schematic design system 200 includes a schematic circuit design module 202, a schematic netlist analysing module 204, a component area parameter module 206, a component information updation module 208, a circuit design optimisation module 210, a component placement layout module 212, and a layout closure module 214. The schematic circuit design module 202 designs the schematic circuit includes the one or more of components to be compatible with circuit specifications of the one or more of components based on a first set of component information. The first set of component information includes a first width of the one or more components, a first length of the one or more components, at least one finger of the one or more components, and at least one multiplier of the one or more components. The component information includes width of the plurality of components, length of the one or more components, and finger of the one or more components, and multiplier of the one or more components. The schematic netlist analysing module 204 performs a schematic netlist analysis on the schematic circuit to compute an area for each of the one or more components in the schematic circuit. The component area parameter module 206 calculates an area of (a) at least one component of the one or more components, (b) at least one component type of the one or more components, and (c) at least one group of components of the one or more components. The component information updation module 208 obtains a second set of component information includes a second length of the one or more components, a second width of the one or more components, at least one finger of the one or more components, and at least one multiplier of the one or more components. The second set of component information is optimised for area based on area parameters includes the area of the (a) at least one component of the one or more components, (b) at least one component type of the one or more components, and (c) at least one group of components of the one or more components. In one embodiment, multiple set of components information is possible. The circuit design optimisation module 210 design and optimise the schematic circuit design based on the second set component information that is optimised for area based on the area parameters. The component placement layout module 212 an optimised component placement layout design based on the second set of component information that is optimised for area based on the area parameters. The layout closure module 214 delivers the optimised component placement layout design as a final output for generating an optimized circuit. The component area parameter verification module 216 performs a verification whether the first set of area parameters meet a pre-defined condition in the first set of component information.

Area utilized by the one or more component in a layout of a schematic circuit varies from area in the schematic circuit on the following three factors, i) DRCs (Design Rule checks) specified by foundries between different types of Metal Oxide Semiconductor (MOS) cells, ii) Capacitance/resistance specification for routings based on a design of the schematic circuit, iii) electro migration rules for routings to meet current specification. By comparing the area of the schematic circuit and area utilized by the one or more component in the layout of the completed blocks, a utilization factor can be obtained. Estimated layout area=area of schematic circuit×utilization factor.

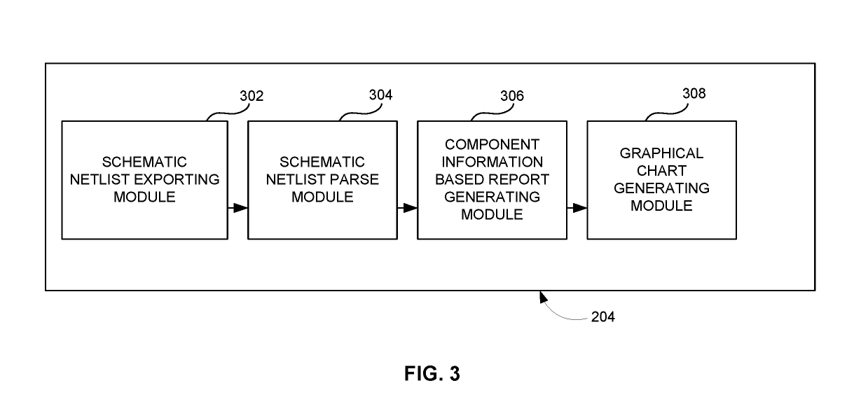

FIG. 3 illustrates an exploded view of a schematic netlist analysing module 204 of FIG. 2 according to embodiment herein. The schematic netlist analysing module 204 includes a schematic netlist exporting module 302, a schematic netlist parse module 304, a component information based report generating module 306, and a graphical chart generating module 308. The schematic netlist exporting module 302 exports a schematic netlist from the schematic circuit. The schematic netlist parse module 304 parses the schematic netlist to obtain the component information associated with the one or more components. The component information based report generating module 306 (a) processes the component information associated with the one or more components to calculate an area of each of the one or more components, and (b) generates an area report based on the area of the one or more components. The graphical chart generating module 308 generates a graphical chart based on the area report using the scripting tools. Examples of the scripting tools include but are not limited to Perl and Tcl. The graphical chart may be a pie chart, a bar chart, a hierarchy chart, a stock chart, a pivot chart, a combo chart, doughnut chart, a bubble chart, a radar chart, an area chart, and a statistic chart. In case of reduced width and length ratio remains same. Based on the ratio, design can be modified to have optimum area with minute or no compromise in performance. Using the graphical chart, a schematic designer attempts to modify Width and Length parameters of a component occupying large areas, such that the performance is least affected.

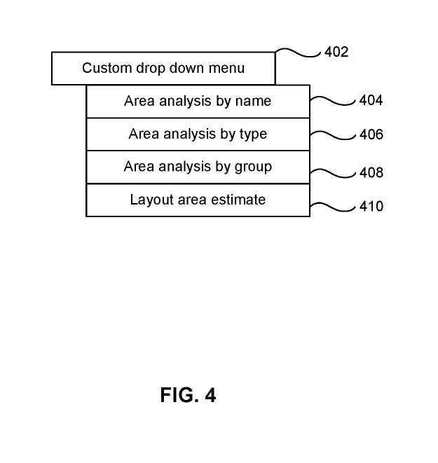

FIG. 4 illustrates an exploded view of a custom dropdown menu 402 of a scripting tool according to an embodiment herein. In one embodiment, the scripting tool includes the custom dropdown menu 402 for generating a graphical chart, and the graphical chart generation is performed when the custom dropdown menu 402 is clicked. The custom dropdown menu 402 includes i) area analysis by name sub-menu 404, ii) area analysis by type sub-menu 406, iii) area analysis by group sub-menu 408, and iv) layout area estimate sub-menu 410. The area analysis by name sub-menu 404 generates the graphical chart based on a name of one or more components. The graphical chart displays an area occupied by the one or more components along with the name of the one or more components. The area analysis by type sub-menu 406 generates the graphical chart based on a type of the one or more components. The graphical chart displays an area occupied by the type of the one or more components (e.g. Pch, nch, crtmom, inductor etc.). The area analysis by group sub-menu 408 generates the graphical chart based on a group of the one or more components. The graphical chart displays an area occupied by the group of the one or more components. The layout area estimate sub-menu 410 generates the graphical chart based on an estimate of area utilization of the one or more components post designing the schematic circuit. For example: Objective:

Given limiting values for phase margin, bandwidth, noise, phase margins for common mode feedback loops and IM3 for a typical two-stage op amp, it is required to come up with suitable dimensions for MOSFETs, capacitors and resistors that make up the operational amplifier.

Procedure: In order to solve the above design problem, an ECL program is written with the aforementioned dimensions being swept over fixed ranges with suitable steps. A coarse run is carried out to find approximate values for these dimensions depending on input specifications, ie. given input specifications, find those dimensions that meet these in typical corner. This coarse run function outputs all sets of suitable dimensions to the function running the finer run.

The limits for sweeps in the fine run are set based on outputs from the coarse run. The steps in the fine run are smaller than those in the former. In each case, phase margin, bandwidth and other required properties are calculated in the typical corners and compared with input specifications. If all input specifications are satisfied, simulations are run for different corners. If the specifications are met in all process corners, a log of the set of dimensions is created. This log is updated with every sweep of dimensions.

Once the sweeps are completed, optimization is done on the total area and power drawn from input. Among those sets that satisfy given specifications (in all process corners), those sets of dimensions which consume power lower than a fixed amount are considered. Further, among these, that set with least total area is chosen.

Thus, given certain specifications for the operational amplifier, a program is written to output suitable dimensions of circuit elements that correspond to least area. This solves a design problem.

For the two-stage fully differential op amp used, parameters that are swept are: (i) Width of first stage input pair (w1), (ii) Width of first stage load pair (w1 p), (iii) Width of second stage input pair (w2), (iv) Width of second stage load pair (w2n), (v) Multiplier for number of fingers in second stage input pair (m), thus sweeping second stage current, (vi) Number of horizontal fingers in capacitor (second stage) (nh), (vii) Number of vertical fingers in capacitor (second stage) (nv), (viii) Length of resistor (second stage) (lr). The specifications for the required properties are obtained by running simulations for the given op amp in all process corners.

Result: The program gives as result those dimensions which correspond to power lower than the original operational amplifier, in addition to optimizing on the area. In the specific case considered, a 6.77% improvement in total area and 10.40% improvement in the power consumed are achieved.

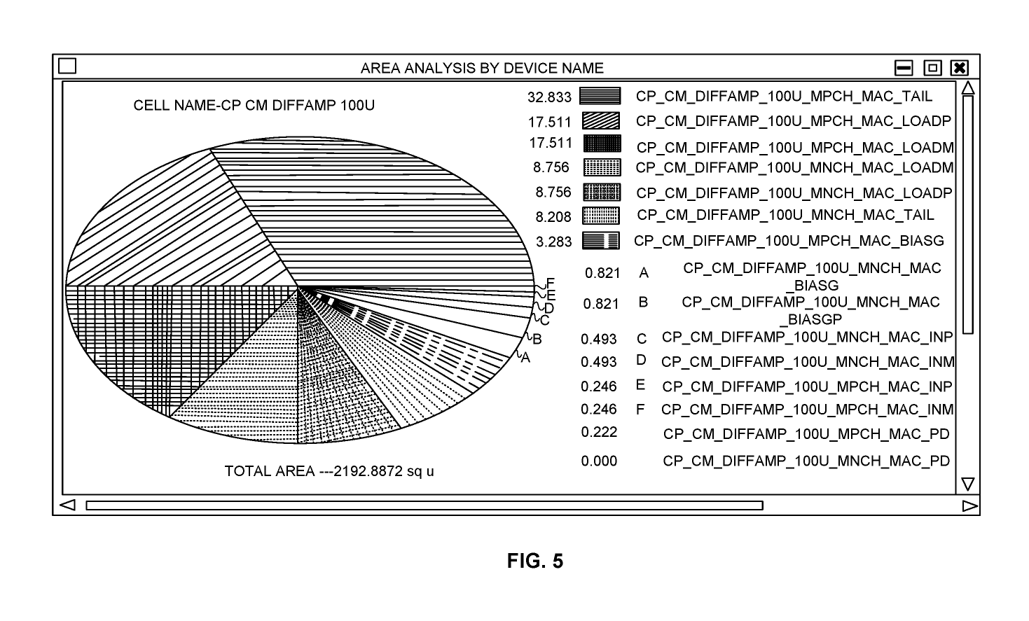

FIG. 5 illustrates a graphical chart of a schematic circuit that is generated using the area analysis by name sub-menu 404 of FIG. 4 according to an embodiment herein. The graphical chart displays an area occupied by the one or more components in the schematic circuit along with the name of the one or more components. In one embodiment, each component in the schematic circuit includes width (W), length (L), finger (F), and multipliers (M). An area of one or more components is calculated by multiplying (a) width of the one or more components, (b) length of the one or more components, (c) finger of the one or more components, and (d) multiplier of the one or more components. A percentage of the area occupied by a component is calculated by dividing the area of the component with a total area of the schematic circuit.

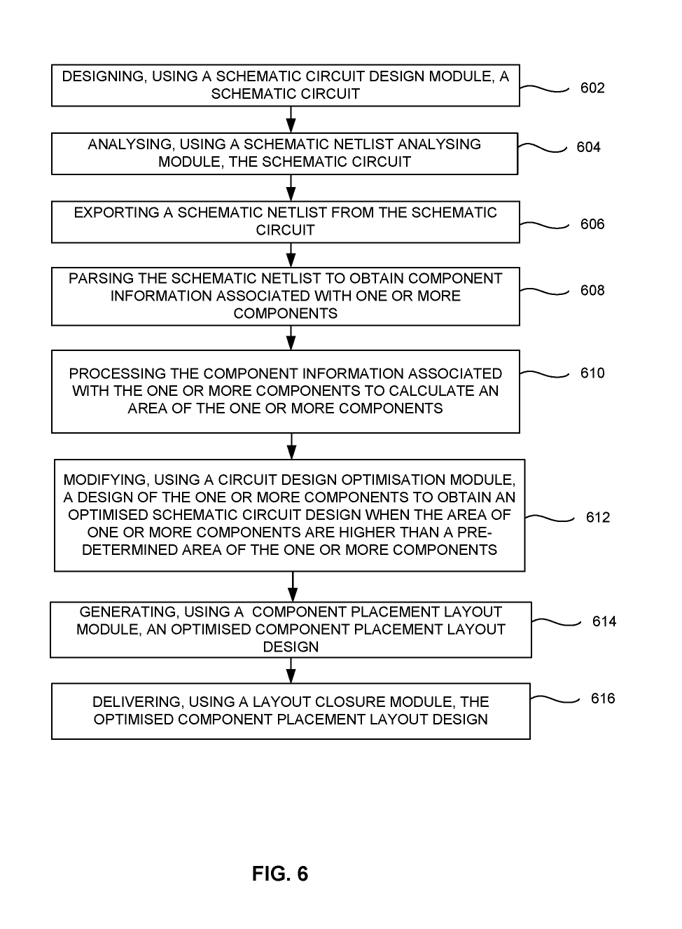

FIG. 6 is a flow diagram that illustrates a method for analyzing an area of one or more components in a schematic circuit using the area aware schematic design system of FIG. 2 according to an embodiment herein. At step 602, a schematic circuit that includes one or more components is designed using the schematic circuit design module 202. The schematic circuit to be compatible with circuit specifications of the one or more components. The one or more components include component information based on a first set of component. The component information includes a first width of said plurality of components, first length of said plurality of components, at least one finger of said plurality of components, and at least one multiplier of said plurality of components. At step 604, the schematic circuit is analysed using the schematic netlist analysing module 204 to compute an area for each of the one or more components in the schematic circuit. At step 606, a schematic netlist is exported from the schematic circuit. At step 608, the schematic netlist is parsed to obtain the component information associated with the one or more components. At step 610, the component information associated with the one or more components is processed to calculate the area of the one or more components. At step 612, a design of the one or more components is modified using the circuit design optimisation module 210 to obtain an optimised schematic circuit design when the area of the one or more components is higher than a pre-determined area of the one or more components. At step 614, an optimised component placement layout design is generated using the component placement layout module 212 based on said second set of component information that is optimised for area based on said area parameters. At step 616, the optimised component placement layout design is delivered using the layout closure module 214 for as a final output for generating an optimized circuit. The method for analyzing the area of the one or more components in the schematic circuit further includes an area report is generated based on the area of the one or more components, and a graphical chart is generated based on the area report using the scripting tools.

The foregoing description of the specific embodiments will so fully reveal the general nature of the embodiments herein that others can by applying current knowledge readily modify and/or adapt for various applications. Such specific embodiments without departing from the generic concept and therefore such adaptations and modifications should intend to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modifications within the spirit and scope of the appended claims.

What is claimed is:

1. An area aware schematic design system that analyses an area of a plurality of components in a schematic circuit using scripting tools to generate an optimised component placement layout design for designing said schematic circuit, said system comprising:
(a) a memory unit that stores a database, and a set of modules; and
(b) a processor that executes said set of modules, wherein said set of modules comprises:
a schematic circuit design module, implemented by said processor, that designs said schematic circuit comprising said plurality of components to be compatible with circuit specifications of said plurality of components based on a first set of component information that comprises a first width of said plurality of components, a first length of said plurality of components, at least one finger of said plurality of components, and at least one multiplier of said plurality of components;
a component area parameter module, implemented by said processor, that calculates an area of (a) at least one component of said plurality of components, (b) at least one component type of said plurality of components, and (c) at least one group of components of said plurality of components;
a component information updation module, implemented by said processor, that obtains a second set of component information comprising a second length of said plurality of components, a second width of said plurality of components, at least one finger of said plurality of components, and at least one multiplier of said plurality of components, wherein said second set of component information is optimised for area based on area parameters comprising said area of said (a) at least one component of said plurality of components, (b) at least one component type of said plurality of components, and (c) at least one group of components of said plurality of components;
a circuit design optimisation module, implemented by said processor, that design and optimise a schematic circuit design based on said second set component information that is optimised for area based on said area parameters;
a component placement layout module, implemented by said processor, that generates an optimised component placement layout design based on said second set of component information that is optimised for area based on said area parameters; and
a layout closure module, implemented by said processor, that delivers said optimised component placement layout design as a final output for generating an optimized circuit.

2. The area aware schematic design system as claimed in claim 1, further comprising:
a schematic netlist analysing module, implemented by said processor, that performs a schematic netlist analysis on said schematic circuit to compute an area for each of said plurality of components in said schematic circuit, wherein said schematic netlist analysing module comprises:
a schematic netlist exporting module, implemented by said processor, that exports a schematic netlist from said schematic circuit;
a schematic netlist parse module, implemented by said processor, that parses said schematic netlist to obtain said component information associated with said plurality of components;
a component information based report generating module, implemented by said processor, that (a) processes said component information associated with said plurality of components to (i) calculate an area for each of said plurality of components, (ii) calculate an area for each of said plurality of components type and (iii) calculate an area for each of said plurality of components group (b) generates an area report based on said area of said plurality of components; and
a graphical chart generating module, implemented by said processor, that generates a graphical chart based on said area report using said scripting tools.

3. The area aware schematic design system as claimed in claim 1, wherein said schematic circuit design module modifies said schematic circuit based on said optimised schematic circuit design.

4. The area aware schematic design system as claimed in claim 1, wherein said second set of component information is obtained based on an iterative process of optimising for area based on said area parameters.

5. The area aware schematic design system as claimed in claim 1, wherein said component area parameter module displays said first area of (a) at least one component of said plurality of components, (b) at least one component type of said plurality of components, and (c) at least one group of components of said plurality of components.

6. The area aware schematic design system as claimed in claim 1, wherein said component information updation module displays said second area of (a) at least one component of said plurality of components, (b) at least one component type of said plurality of components, and (c) at least one group of components of said plurality of components.

7. The area aware schematic design system as claimed in claim 1, further comprising a component area parameter verification module that performs a verification whether said first set of area parameters meet a pre-defined condition in said first set of component information, wherein said component information updation module determines said second set of component information based on a result of said verification.

8. The area aware schematic design system as claimed in claim 1, wherein said second set of component information is generated by reducing at least one of said area by component, said area by component type, said area by component group for at least one of lower priority comp type or group.

9. An area aware schematic design system that analyses an area of a plurality of components in a schematic circuit using scripting tools to generate an optimised component placement layout design for designing said schematic circuit, comprising:
(a) a memory unit that stores a database, and a set of modules; and
(b) a processor that executes said set of modules, wherein said set of modules comprises:
a schematic circuit design module, implemented by said processor, that designs said schematic circuit comprising said plurality of components to be compatible with circuit specifications of said plurality of components based on a first set of component information that comprises a first width of said plurality of components, first length of said plurality of components, at least one finger of said plurality of components, and at least one multiplier of said plurality of components, wherein said schematic circuit design module modifies said schematic circuit based on said optimised schematic circuit design;
a schematic netlist analysing module, implemented by said processor, that performs a schematic netlist analysis on said schematic circuit to compute an area for each of said plurality of components in said schematic circuit, wherein said schematic netlist analysing module comprises:
a schematic netlist exporting module, implemented by said processor, that exports a schematic netlist from said schematic circuit;
a schematic netlist parse module, implemented by said processor, that parses said schematic netlist to obtain said component information associated with said plurality of components;
a component information based report generating module, implemented by said processor, that (a) calculates said component information associated with said plurality of components to (i) calculate an area for each of said plurality of components, (ii) calculate an area for each of said plurality of components type and (iii) calculate an area for each of said plurality of components group (b) generates an area report based on said area of said plurality of components; and
a graphical chart generating module, implemented by said processor, that generates a graphical chart based on said area report using said scripting tools;
a component area parameter module, implemented by said processor, that calculates an area of (a) at least one component of said plurality of components, (b) at least one component type of said plurality of components, and (c) at least one group of components of said plurality of components, wherein said component area parameter module displays said first area of (a) at least one component of said plurality of components, (b) at least one component type of said plurality of components, and (c) at least one group of components of said plurality of components;
a component information updation module, implemented by said processor, that obtains a second set of component information comprising a second length of said plurality of components, a second width of said plurality of components, at least one finger of said plurality of components, and at least one multiplier of said plurality of components, wherein said second set of component information is optimised for area based on area parameters comprising said area of said (a) at least one component of said plurality of components, (b) at least one component type of said plurality of components, and (c) at least one group of components of said plurality of components, wherein said second set of component information is obtained based on an iterative process of optimising for area based on said area parameters, wherein said component information updation module displays said second area of (a) at least one component of said plurality of components, (b) at least one component type of said plurality of components, and (c) at least one group of components of said plurality of components, wherein said second set of component information is generated by reducing at least one of said area by component, said area by component type, said area by component group for at least one of lower priority comp type or group;
a circuit design optimisation module, implemented by said processor, that modifies a design of said plurality of components to obtain an optimised schematic circuit design when said area of said plurality components are higher than a pre-determined area of said plurality of components;
a component placement layout module, implemented by said processor, that generates an optimised component placement layout design based on said second set of component information that is optimised for area based on said area parameters;
a layout closure module, implemented by said processor, that delivers said optimised component placement layout design as a final output for generating an optimized circuit; and
a component area parameter verification module that performs a verification whether said first set of area parameters meet a pre-defined condition in said first set of component information, wherein said component information updation module determines said second set of component information based on a result of said verification.

10. The area aware schematic design system as claimed in claim 9, wherein said scripting tools comprises a custom dropdown menu, wherein said custom dropdown menu (402) comprises:
an area analysis by name sub-menu that is configured to generate said graphical chart based on a name of said plurality of components, wherein said graphical chart displays an area occupied by said plurality of components along with said name of said plurality of components;
an area analysis by type sub-menu that is configured to generate said graphical chart based on a type of said plurality of components, wherein said graphical chart displays an area occupied by said type of said plurality of components;
an area analysis by group sub-menu that is configured to generate said graphical chart based on a group of said plurality of components, wherein said graphical chart displays an area occupied by said group of said plurality of components; and
a layout area estimate sub-menu that is configured to generate said graphical chart based on an estimate of area utilization of said plurality of components post designing said schematic circuit;

11. The area aware schematic design system as claimed in claim 9, wherein said second set of component information is determined based on a percentage of an area occupied by a component, which is calculated by dividing said area of said component with a total area of said schematic circuit.

12. The area aware schematic design system as claimed in claim 9, wherein said area of said plurality of components is calculated by multiplying (a) width of said plurality of components, (b) length of said plurality of components, (c) finger of said plurality of components, and (d) multiplier of said plurality of components.

13. A method for analysing an area of plurality of components in a schematic circuit using scripting tools to generate an optimised component placement layout design for designing said schematic circuit, said method comprising:
designing said schematic circuit comprising said plurality of components to be compatible with circuit specifications of said plurality of components, based on a first set of component information that comprises a first width of said plurality of components, first length of said plurality of components, at least one finger of said plurality of components, and at least one multiplier of said plurality of components;
analysing said schematic circuit to compute said area for each of said plurality of components in said schematic circuit, wherein said analyzing comprises:
exporting a schematic netlist from said schematic circuit;
parsing said schematic netlist to obtain said component information associated with said plurality of components; and
processing said component information associated with said plurality of components to calculate an area of said plurality of components;
modifying, using a circuit design optimisation module, a design of said plurality of components to obtain an optimised schematic circuit design when said area of said plurality of components are higher than a pre-determined area of said one or more components;
generating an optimised component placement layout design based on said second set of component information that is optimised for area based on said area parameters; and
delivering said optimised component placement layout design as a final output for generating an optimized circuit.

14. The method as claimed in claim 13, further comprising:
generating an area report based on said area of said plurality of components; and
generating a graphical chart based on said area report using said scripting tools.
